(19) United States
(12) Patent Application Publication
(10) Pub. No.: US 2023/0036741 A1
(43) Pub. Date: Feb. 2, 2023

(54) TIMING CONTROLLERS FOR DISPLAY CALIBRATION

(71) Applicant: Hewlett-Packard Development Company, L.P., Spring, TX (US)

(72) Inventors: Thong Thai, Spring, TX (US); Gregory Staten, Spring, TX (US); Syed Azam, Spring, TX (US)

(73) Assignee: Hewlett-Packard Development Company, L.P., Spring, TX (US)

(21) Appl. No.: 17/791,229

(22) PCT Filed: Feb. 14, 2020
(86) PCT No.: PCT/US2020/018372

§ 371 Date: Jul. 7, 2022

(51) Int. Cl. G09G 3/20

(52) U.S. Cl. CPC G09G 3/2096; G09G 2320/0673; G09G 2320/0693; G09G 2360/08; G09G 2360/16

(57) ABSTRACT

Examples of timing controllers (TCONs) for display calibration are described. In some examples, a command to enter a built-in self-test (BIST) calibration mode for calibration of the display may be received at a TCON. A BIST circuit of the TCON may generate optical calibration patterns to be displayed by the display.

### BACKGROUND

Electronic devices such as computing devices may display data. For example, an electronic device may cause data to be displayed by a display. In some examples, the display may be integrated with the electronic device. In other examples, the display may be separate from the electronic device.

### BRIEF DESCRIPTION OF THE DRAWINGS

Various examples will be described below by referring to the following figures.

FIG. 1 is a block diagram of an example of a display with a timing controller (TCON) for display calibration;

FIG. 2 is a flow diagram illustrating an example of a method for display calibration;

FIG. 3 is a block diagram illustrating an example of a display with a TCON and a calibration engine for display calibration;

FIG. 4 is a block diagram illustrating an example of display calibration for a display with a host computing device;

FIG. 5 is a block diagram illustrating an example of display calibration for a display without a host computing device;

FIG. 6 is a flow diagram illustrating an example of a method for display calibration; and

FIG. 7 is a flow diagram illustrating an example of a method for display calibration.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

Electronic devices such computing devices (e.g., laptop computers, desktop computers, tablet devices, smartphones, gaming systems, medical devices, etc.) may use a display to present information in a visual format. In some cases, the display may be calibrated to ensure that the displayed image matches the digital signal provided to the display.

In some approaches, a display may be calibrated using the operating system (OS) and/or graphics processing unit (GPU) of a host computing device. For example, a calibration engine may use an operating system's application programming interface (API) to request the display to draw a full-screen red-green-blue (RGB) pattern on the display. Upon receiving the request, the OS may request the GPU to output the pattern to the display. The calibration engine may measure the pattern with an optical instrument and perform calibration (e.g., color correction) for the display.

However, with these approaches, the OS and/or GPU may have color processing pipelines with behaviors that are not always detectable or understood at the point of calibration. These approaches rely on a host or an external pattern generator such that the host is dependent on a GPU and an operating system to generate the calibration pattern accurately. Furthermore, generating calibration patterns using a host device may involve first analyzing the calibration patterns for accuracy and then correcting the calibration patterns. Therefore, the calibration may rely upon changes in the OS and/or the GPU, which may add cost and complexity to display calibration. Additionally, accurate generation of calibration patterns for some display formats (e.g., high-dynamic range (HDR)) may not be supported by some operating systems.

In other approaches, some displays may use an on-screen display (OSD) overlay generator to display a calibration pattern. However, the OSD may not exist for all displays. Additionally, the use of an OSD for calibration may be time-intensive due to limited automation of the OSD.

The examples described herein use a built-in self-test (BIST) circuit in a timing controller (TCON) of a display to generate optical calibration patterns (e.g., RGB patterns) for calibration of the display. Therefore, the BIST circuit of the TCON may generate optical calibration patterns (e.g., RGB patterns) either automatically or as instructed (e.g., by a calibration engine). An optical sensor (e.g., a colorimeter, spectroradiometer, etc.) may then be used to measure the optical calibration patterns. These calibration measurements may be used to characterize performance of the display and validate the calibration applied to the display.

In some examples, a hardware signal may be used to instruct the TCON to enter a BIST calibration mode. In some examples, the hardware signal may be a pull-up or pull-down strap on a GPIO (general-purpose input/output) line. The BIST circuit may generate defined optical calibration patterns (e.g., RGB patterns) within a defined time-lapse for each optical calibration pattern. Once the color calibration is completed, calibration data (e.g., color correction data, look-up tables (LUTs), etc.) may be stored in memory of the display that is accessible to the TCON storage. Thus, the display calibration may be completely independent of a host computing device or an external calibration pattern generator. The described examples provide an accurate calibration process by having no dependency on external sources, which may introduce errors into the color processing.

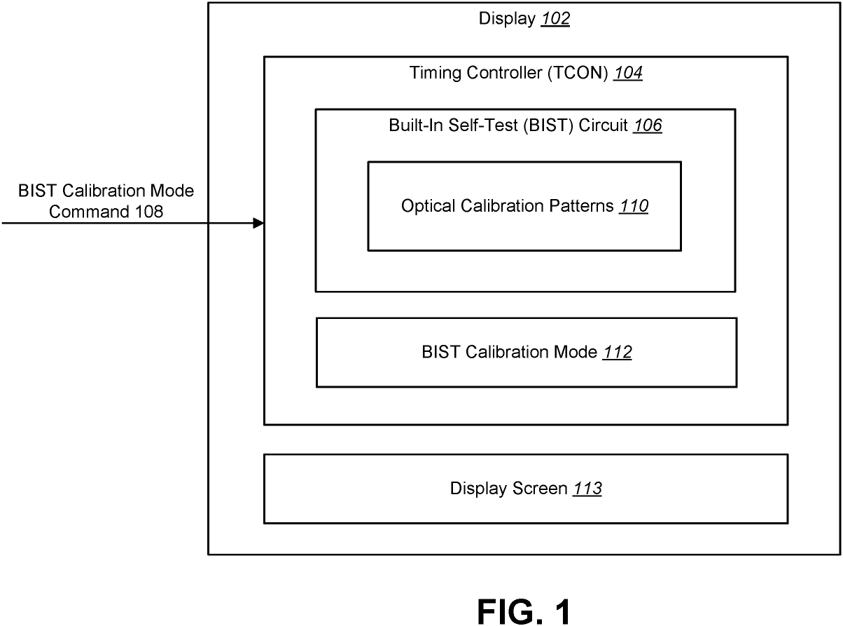

FIG. 1 is a block diagram of an example of a display 102 with a timing controller (TCON) 104 for display calibration. In some examples, the display 102 may be integrated with a computing device, such as a laptop computer, a smartphone, a tablet computer, a handheld gaming console, etc. In other examples, the display 102 may be separate from a computing device. For instance, the display 102 may be a monitor that receives a video signal from a remote computing device (e.g., a desktop computer, gaming console, etc.).

In some examples, the display 102 may include a display screen 113 to display visual images. The display 102 may be a device that includes the display screen 113 and circuitry to operate the display screen 113. In some examples, the display screen 113 may be a panel (e.g., a liquid crystal display (LCD) panel). In some examples, the display 102 may be a color display. In these examples, the display 102 may implement different colors using a color model (e.g., red-green-blue (RGB), RGB yellow (RGBY), RGB white (RGBW), etc.). In other examples, the display 102 may be a monochrome display (e.g., grayscale display).

The display 102 may include a timing controller (TCON) 104. In some examples, the TCON 104 may be a combination of circuits and executable instructions. The TCON 104 may receive image data and may convert the image data into a format that can be displayed by the display screen 113. For example, the TCON 104 may synchronize image data received from a graphics processing unit (GPU) or central processing unit (CPU) of a host computing device for presentation by the display screen 113.

In some examples, the TCON 104 may be attached to or coupled with the display screen 113 (e.g., LCD panel). The TCON 104 may translate between a received video signal and the row and column driver signaling of the display screen 113. In some examples, the TCON 104 may be an application-specific integrated circuit (ASIC) or other integrated circuit (IC).

The TCON 104 may include a built-in self-test (BIST) circuit 106. In some examples, the BIST circuit 106 may be test circuitry used to allow the TCON 104 to test itself. For example, the TCON 104 may use the BIST circuit 106 to verify that it is working correctly. In some examples, the BIST circuit 106 may perform testing of the TCON 104 during power-up of the TCON 104. In other examples, the BIST circuit 106 may be commanded to perform testing of the TCON 104. The BIST circuit 106 may also output color patterns on the display 102 for visual inspection.

The BIST circuit 106 may be leveraged for display calibration. For example, the BIST circuit 106 may generate optical calibration patterns 110 to be displayed by the display 102. These optical calibration patterns 110 may be used to calibrate the display 102. The BIST circuit 106 may cause a defined pattern to be displayed on the display. As used herein, an optical calibration pattern 110 is visual information that is displayed by the display 102. An optical calibration pattern 110 may have known properties (e.g., color values, hue, intensity, etc.). Therefore, the optical calibration patterns 110 generated by the BIST circuit 106 may be multiple images that each have defined properties. In some examples, the optical calibration patterns 110 may a series of full-screen RGB patterns.

In some examples, the optical calibration patterns 110 may include RGB triplets that are displayed by the display 102. It should be noted that other color models besides RGB may be used for the optical calibration patterns 110 based on the color model used by the display 102. For example, if the display 102 is an RGBY or RGBW display, the optical calibration patterns 110 may match these color models. In other examples, the optical calibration patterns 110 may be generated in monochrome for a monochrome display.

In an example, the optical calibration patterns 110 may be an RGB triplet. In this case, a given optical calibration pattern 110 is a uniform color. In an example for an 8-bit display, a first optical calibration pattern 110 may be R=255, G=0, B=0, which means a full intensity red pattern. A second optical calibration pattern 110 may be R=0, G=255, B=0, which means a full intensity green pattern. A third optical calibration pattern 110 may be R=0, G=0, B=255, which means a full intensity blue pattern. A fourth optical calibration pattern 110 may be R=255, G=255, B=255, which means a full intensity white pattern. In addition to these examples, other RGB triplet values may be used to generate the optical calibration patterns 110.

In some examples, the BIST circuit 106 may cause the optical calibration patterns 110 to be displayed with a defined time-lapse for each optical calibration pattern 110. For example, the BIST circuit 106 may generate one optical calibration pattern 110 for a certain period of time. The BIST circuit 106 may then generate another optical calibration pattern 110 for a certain period of time, and so forth. The amount of time used for the defined time-lapse may be preconfigured in the BIST circuit 106 or may be communicated to the BIST circuit 106.

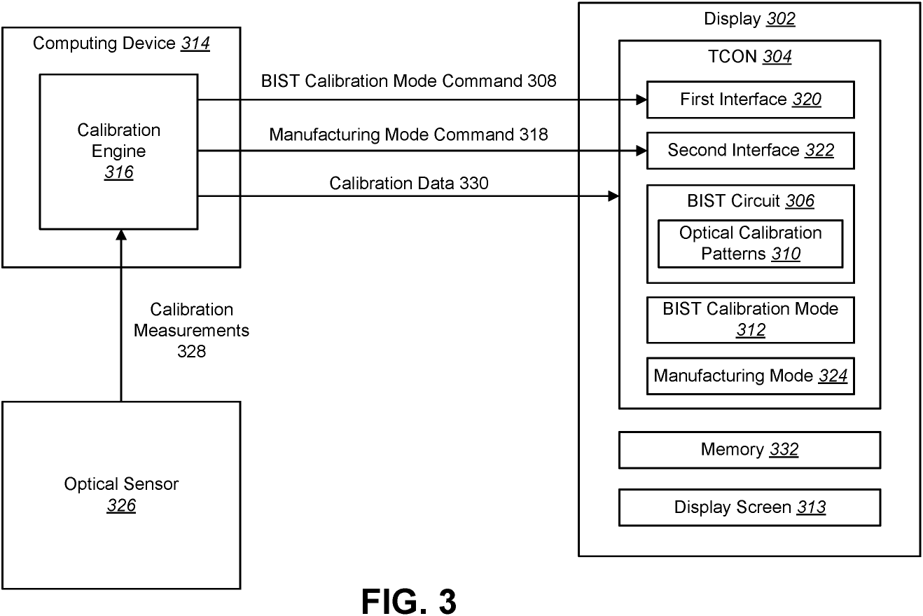

The properties for a given optical calibration pattern 110 may be communicated to or may be known by an external calibration device. For example, an external calibration engine may be used to calibrate the display 102 based on the optical calibration patterns 110 generated by the BIST circuit 106. In some examples, an optical sensor (e.g., a colorimeter, spectroradiometer, etc.) may measure the optical calibration patterns 110. Using the calibration measurements obtained by the optical sensor, the calibration engine may determine calibration data to calibrate the display 102. An example of this approach is described in connection with FIG. 3.

In some examples, the TCON 104 may enter a BIST calibration mode 112 in response to receiving a command 108 to enter the BIST calibration mode 112 for calibration of the display 102. For example, the BIST calibration mode command 108 may be received from a remote computing device. In some examples, the remote computing device sending the BIST calibration mode command 108 may be located in close proximity to the display 102. For instance, the remote computing device may be a factory calibration device running a calibration engine. In this case, the remote computing device may communicate with the TCON 104 using a direct wired connection. In other examples, the remote computing device sending the BIST calibration mode command 108 may communicate with the TCON 104 using a network connection. In some examples, the remote computing device sending the BIST calibration mode command 108 may be a cloud-based computing device that communicates with the TCON 104 over an Internet connection.

Upon receiving the BIST calibration mode command 108, the TCON 104 may enter BIST calibration mode 112. The TCON 104 may disregard signals received at a display interface in response to entering the BIST calibration mode 112. For example, if the TCON 104 is connected to a host computing device, the TCON 104 may disregard any video signals sent by the host computing device on a video interface. Furthermore, upon entering BIST calibration mode 112, the TCON 104 may activate the BIST circuit 106 for generating the optical calibration patterns 110.

The BIST circuit 106 may generate the optical calibration patterns 110 either automatically or as instructed. In some examples, the BIST circuit 106 may automatically start generating the optical calibration patterns 110 in response to the TCON 104 receiving the BIST calibration mode command 108. In other examples, the BIST circuit 106 may wait for an instruction to begin generating the optical calibration patterns 110 after the TCON 104 enters BIST calibration mode 112. In this case, a remote calibration engine may send an instruction to generate the optical calibration patterns 110 to the TCON 304. Upon receiving this instruction, the BIST circuit 106 may generate the optical calibration patterns 110 that are to be displayed by the display 102.

By using the BIST circuit 106 of the TCON 104, color calibration can be completely independent of a host computing device, or external color pattern generator. Because the optical calibration patterns 110 are generated internally, the calibration pattern generation is completely independent of the operating system and the GPU on the host computing device. In some examples, this may enable a streamlined, accurate process by having no dependency on other external sources, which may introduce color processing that needs to be understood and overcome to properly generate patterns for color calibration and validation.

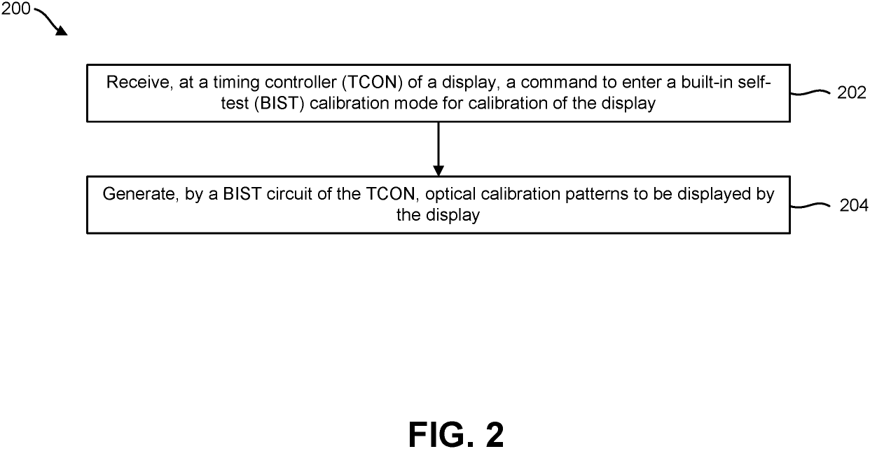

FIG. 2 is a flow diagram illustrating an example of a method 200 for display calibration. The method 200 may be performed by, for example, a timing controller (TCON) 104 of a display 102.

The TCON 104 receives 202 a command 108 to enter a built-in self-test (BIST) calibration mode for calibration of the display. In some examples, the BIST calibration mode command 108 may be received 202 from a remote computing device (e.g., a computing device implementing a calibration engine). In other examples, the received BIST calibration mode command 108 may be the display 102 powering up. For example, while the display 102 is in a manufacturing mode, the TCON 104 may enter BIST calibration mode 112 when the display 102 powers on.

Upon receiving 202 the BIST calibration mode command 108, the TCON 104 may enter BIST calibration mode 112. The TCON 104 may disregard signals received at a display interface in response to entering the BIST calibration mode 112.

The TCON 104 generates 204, using a BIST circuit 106, optical calibration patterns 110 to be displayed by the display 102. For example, the BIST circuit 106 may generate defined optical calibration patterns 110 for color calibration of the display 102. In some examples, the optical calibration patterns 110 may include red-green-blue (RGB) triplets displayed by the display 102. It should be noted that the optical calibration patterns 110 may be formatted for other color models or monochrome models based on the display 102.

In some examples, the BIST circuit 106 may cause the optical calibration patterns 110 to be displayed with a defined time-lapse for each optical calibration pattern 110. For example, the BIST circuit 106 may generate one optical calibration pattern 110 for a certain period of time. The BIST circuit 106 may then generate another optical calibration pattern 110 for a certain period of time, and so forth.

FIG. 3 is a block diagram illustrating an example of a display 302 with a TCON 304 and a calibration engine 316 for display calibration. The display 302 may be implemented in accordance with the display 102 described in FIG. 1.

The display 302 may include a TCON 304, memory 332 and a display screen 313. The memory 332 may be any electronic, magnetic, optical, or other physical storage device that contains or stores electronic information (e.g., instructions and/or data). The memory 332 may be, for example, Random Access Memory (RAM), Electrically Erasable Programmable Read-Only Memory (EEPROM), a storage device, an optical disc, and the like. In some examples, the memory 332 may be volatile and/or non-volatile memory, such as Dynamic Random Access Memory (DRAM), EEPROM, magnetoresistive random-access memory (MRAM), phase change RAM (PCRAM), memristor, flash memory, and the like. The memory 332 is a non-transitory tangible machine-readable storage medium, where the term “non-transitory” does not encompass transitory propagating signals. In some examples, the memory 332 may include multiple devices (e.g., a RAM card and a solid-state drive (SSD)). The memory 332 may be included within the TCON 304. In other examples, the memory 332 may be located outside the TCON 304.

Examples of the display screen 313 include color and/or monochrome LCD panels, organic light-emitting diode (OLED) panels, quantum dot LED (QLED) panels, etc. Other examples of the display screen 313 include cathode ray tube (CRT) screens, electronic ink (E Ink) displays, plasma displays, etc.

The TCON 304 may include a number of interfaces to communicate with external computing devices (e.g., computing device 314). In some examples, the TCON 304 may include a first interface 320 to receive a command 308 to enter a built-in self-test (BIST) calibration mode 312 for calibration of the display 302. In some examples, the first interface 320 may be a general-purpose input/output (GPIO) line of the TCON 304. The first interface 320 may receive a pull-up signal or pull-down signal to enter the BIST calibration mode 312.

In some examples, the computing device 314 may implement a calibration engine 316. The computing device 314 may include and/or may be coupled to a processor and/or memory (not shown). The processor may be any of a central processing unit (CPU), a semiconductor-based microprocessor, GPU, field-programmable gate array (FPGA), an application-specific integrated circuit (ASIC), and/or other hardware device suitable for retrieval and execution of instructions stored in the memory. The processor may fetch, decode, and/or execute instructions stored in the memory. In some examples, the processor may include an electronic circuit or circuits that include electronic components for performing a function or functions of the instructions (e.g., calibration engine 316).

The memory of the computing device 314 may be any electronic, magnetic, optical, or other physical storage device that contains or stores electronic information (e.g., instructions and/or data). The memory may be, for example, RAM, EEPROM, a storage device, an optical disc, and the like. In some examples, the memory may be volatile and/or non-volatile memory, such as DRAM, EEPROM, MRAM, PCRAM, memristor, flash memory, and the like. In some implementations, the memory may be a non-transitory tangible machine-readable storage medium, where the term “non-transitory” does not encompass transitory propagating signals. In some examples, the memory may include multiple devices (e.g., a RAM card and a SSD).

In some examples, the computing device 314 may include an input/output interface through which the processor may communicate with an external device or devices (e.g., display 302, optical sensor 326, etc.), for instance, to receive and store information (e.g., calibration measurements 328) and send information (e.g., calibration data 330). The input/output interface may include hardware and/or machine-readable instructions to enable the processor to communicate with the external device or devices. The input/output interface may enable a wired or wireless connection to the external device or devices (e.g., display 302, optical sensor 326, etc.). The input/output interface may further include a network interface card and/or may also include hardware and/or machine-readable instructions to enable the processor to communicate with various input and/or output devices, such as a keyboard, a mouse, a touchscreen, a microphone, a controller, another apparatus, electronic device, computing device, etc., through which a user may input instructions into the computing device 314.

In some examples, the calibration engine 316 may be a combination of circuits and executable instructions. In some examples, the calibration engine 316 may be implemented by a processor executing instructions stored in memory.

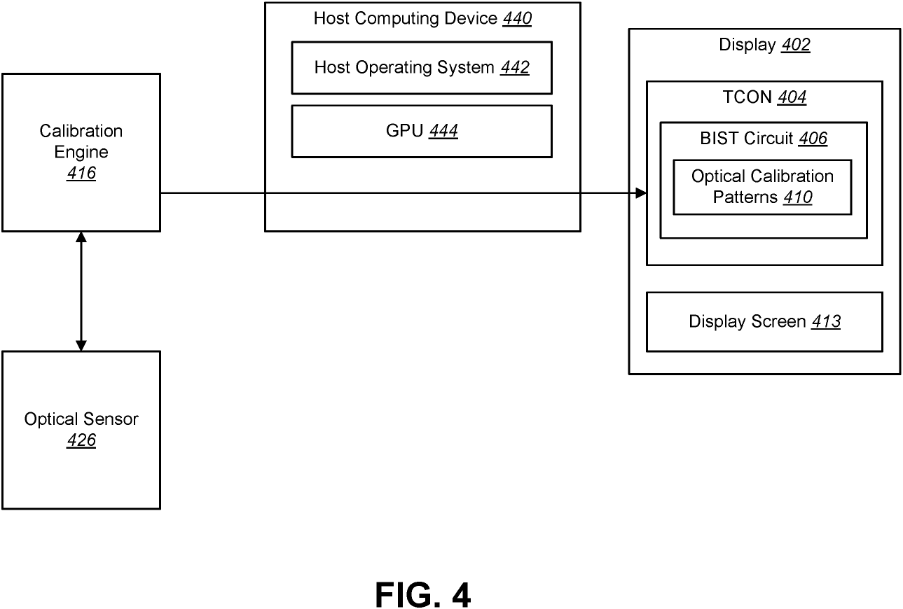

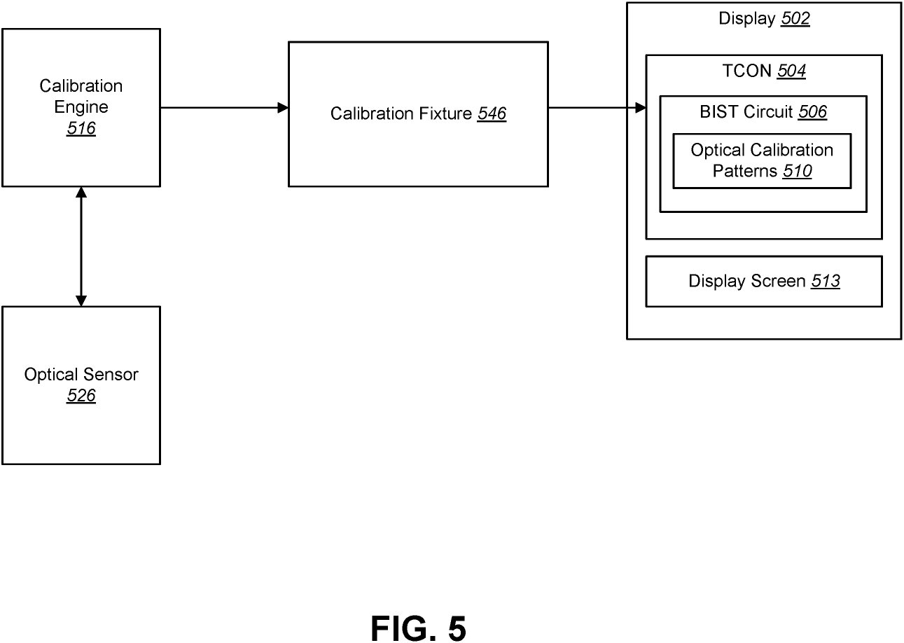

In some examples, the calibration engine 316 may communicate directly with the TCON 304. An example of this approach is described in FIG. 4. In other examples, the calibration engine 316 may communicate with the TCON 304 via an intermediary calibration fixture. An example of this approach is described in FIG. 5.

In some examples, the calibration engine 316 may send, to the TCON 304 of the display 302, a command 308 to enter a BIST calibration mode 312 for calibration of the display 302. In some examples, the calibration engine 316 may send commands (e.g., eDP AUX commands) directly to the TCON 304 of the display 302 to enter BIST calibration mode 312. In other examples, a pull-up or pull-down signal on the GPIO line of the TCON 304 may be used to instruct the TCON 304 to enter BIST calibration mode 312.

Upon entering BIST calibration mode 312, the BIST circuit 306 may generate optical calibration patterns 310. In some examples, the BIST circuit 306 may automatically generate the optical calibration patterns 310 upon entering BIST calibration mode 312. In other examples, the calibration engine 316 may send an instruction to generate the optical calibration patterns 310. Upon receiving the instruction from the calibration engine 316, the BIST circuit 306 may generate optical calibration patterns 310.

In some examples, the calibration engine 316 may use an optical sensor 326 to obtain calibration measurements 328 of the optical calibration patterns 310. In some examples, the optical sensor 326 may be a device (e.g., a colorimeter, spectroradiometer, etc.) that can measure the optical calibration patterns 310. For example, the optical sensor 326 may measure wavelength and amplitude of the light emitted from the display screen 313. In other examples, the optical sensor 326 may filter the light emitted from the display screen 313 to obtain calibration measurements 328.

Upon receiving the calibration measurements 328, the calibration engine 316 may determine calibration data 330 to calibrate the display 302. For example, the calibration engine 316 may compare expected light properties of the display screen 313 with the calibration measurements 328. Based on this comparison, the calibration engine 316 may determine correction values that the TCON 304 is to apply to adjust the display 302.

In some examples, the calibration data 330 includes instructions for how the display 302 is to adjust the light emitted by the display screen 313. The calibration data 330 may be determined to ensure accurate color (or monochrome) reproduction by the display 302. In some examples, the calibration data 330 may include color correction lookup tables (LUTs).

The calibration engine 316 may send the calibration data 330 to the TCON 304. Upon receiving the calibration data 330, the TCON 304 may store the calibration data 330 in memory 332 of the display 302. The TCON 304 may apply the calibration data 330 to adjust display performance (e.g., color performance). For example, the TCON 304 may adjust the light emitted by the display screen 313 based on color correction lookup tables included in the calibration data 330.

In some examples, the calibration engine 316 may validate the calibration data 330 as applied by the TCON 304 to assess the performance of the calibrated display 302. For this validation process, optical calibration patterns 310 may be generated using the calibration data 330. For example, the calibration engine 316 may send, to the TCON 304, an instruction to generate optical calibration patterns 310 using the calibration data 330. Upon receiving this instruction, the BIST circuit 306 may generate the optical calibration patterns 310 while making adjustments to the emitted light according to the calibration data 330. For instance, the BIST circuit 306 may generate optical calibration patterns 310 while adjusting the color according to a color correction lookup table included in the calibration data 330.

As part of the validation process, the optical sensor 326 may obtain measurements 328 of the optical calibration patterns 310 generated using the calibration data 330. If the calibration measurements 328 match the expected properties of the optical calibration patterns 310, then the calibration data 330 is validated. For color displays, this validation process may be used to validate the color performance of the calibrated display 302.

In some examples, the TCON 304 may also include a second interface 322 to receive a command 318 to enter a manufacturing mode 324. In some examples, the second interface 322 may be a GPIO line on the TCON 304. In some examples, the manufacturing mode 324 may be used to allow the TCON 304 to enter BIST calibration mode 312. Therefore, the manufacturing mode 324 may be an unlocking mechanism to ensure that the display 302 does not enter BIST calibration mode 312 accidentally or outside certain environments (e.g., a factory, assembly facility, service facility, etc.). In other words, the manufacturing mode 324 may restrict access to the calibration mode 312. If the TCON 304 is not in manufacturing mode 324, then the TCON 304 will not enter BIST calibration mode 312 even if the TCON 304 receives a BIST calibration mode command 308.

In some examples, the calibration of the display 302 may occur once. For instance, the calibration engine 316 and TCON 304 may be used to calibrate the display 302 during manufacture of the display 302. In other examples, the display 302 may be recalibrated by causing the TCON 304 to enter BIST calibration mode 312. During recalibration, the BIST circuit 306 may regenerate optical calibration patterns 310 that are measured and validated using the calibration engine 316 and optical sensor 326.

FIG. 4 is a block diagram illustrating an example of display calibration for a display 402 with a host computing device 440. In this example, the display 402 may be connected to a host computing device 440. For instance, the display 402 may be integrated with a notebook computer, a tablet computer, a smartphone, etc. In this example, the host computing device 440 may include a host operating system 442 and a GPU 444. In some examples, the host computing device 440 may provide power to the display 402.

The display 402 may include a TCON 404 with a BIST circuit 406 to generate optical calibration patterns 410 for a display screen 413, as described in connection with FIG. 1 and FIG. 3. In this example, the calibration engine 416 may send a command (e.g., an eDP AUX command) directly to the TCON 404 to enter BIST calibration mode and generate optical calibration patterns 410. In other words, the calibration engine 416 may bypass the color processing pipelines of the host operating system 442 and the GPU 444. Instead, the BIST circuit 406 may independently generate the optical calibration patterns 410. While the TCON 404 is in BIST calibration mode, the TCON 404 may disregard signals received from the host computing device 440.

The calibration engine 416 may use an optical sensor 426 to measure the optical calibration patterns 410 displayed by the display screen 413. The calibration engine 416 may then determine calibration data (e.g., color correction lookup tables) for the TCON 404. This may be accomplished as described in FIGS. 1-3.

The optical calibration pattern generation is independent of the host computing device 440. Therefore, the display calibration avoids issues with the color processing pipelines of the host operating system 442 and the GPU 444.

FIG. 5 is a block diagram illustrating an example of display calibration for a display 502 without a host computing device. In this example, the display 502 may be connected to a calibration fixture 546. In some examples, the calibration fixture 546 may be a device to provide power and GPIO strapping to the display 502. The calibration fixture 546 may facilitate communication between a calibration engine 516 and a TCON 504.

The display 502 may include the TCON 504 with a BIST circuit 506 to generate optical calibration patterns 510 for a display screen 513, as described in connection with FIG. 1 and FIG. 3. In this example, the calibration engine 516 may send a command to start the calibration process to the calibration fixture 546. A hardware signal (e.g., a pull-up signal or pull-down signal on a GPIO line) may be used by the calibration fixture 546 to instruct the TCON 504 to enter BIST calibration mode. For instance, when the display 502 powers up, the TCON 504 may detect the hardware signal from the calibration fixture 546 and enters BIST calibration mode. Upon entering BIST calibration mode, the BIST circuit 506 may generate optical calibration patterns 510.

The calibration engine 516 may use an optical sensor 526 to measure the optical calibration patterns 510 displayed by the display screen 513. The calibration engine 516 may then determine calibration data (e.g., color correction lookup tables) for the TCON 504. This may be accomplished as described in FIGS. 1-3.

In this example, the optical calibration pattern generation is completely independent of a host computing device. Therefore, the display calibration avoids issues with the color processing pipelines of the host operating system and the GPU.

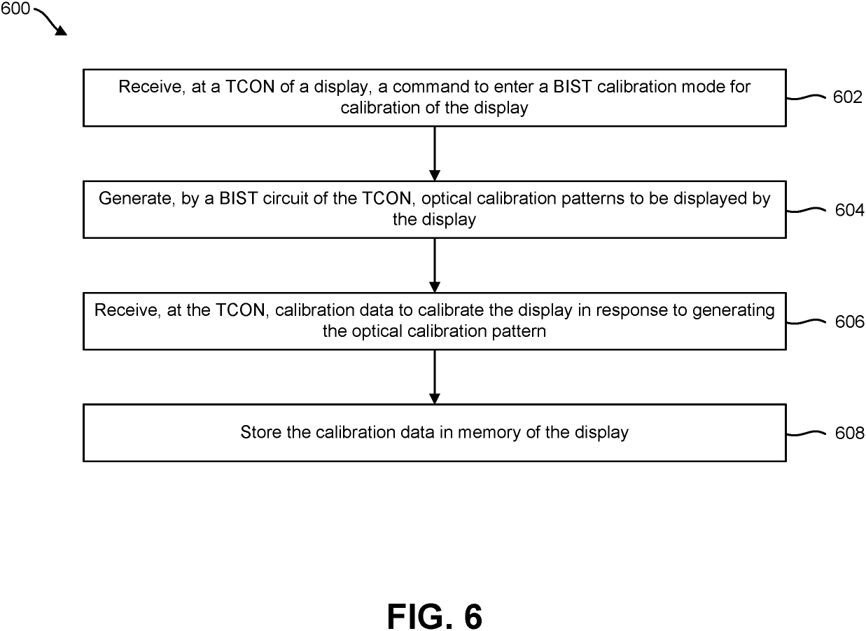

FIG. 6 is a flow diagram illustrating another example of a method 600 for display calibration. The method 600 may be performed by, for example, a TCON 304 of a display 302.

The TCON 304 receives 602 a command 308 to enter BIST calibration mode 312 for calibration of the display 302. In some examples, the BIST calibration mode command 308 may be received 602 directly from a calibration engine 316. In other examples, the BIST calibration mode command 308 may be communicated to the TCON 304 from a calibration fixture 546. For example, a hardware signal from the calibration fixture 546 communicated on the GPIO line of the TCON 304 may cause the TCON 304 to enter BIST calibration mode 312.

The TCON 304 generates 604, using a BIST circuit 306, optical calibration patterns 310 to be displayed by the display 302. This may be accomplished as described in connection with FIG. 2.

The TCON 304 receives 606 calibration data 330 to calibrate the display 302 in response to generating 604 the optical calibration patterns 310. For example, a calibration engine 316 may use an optical sensor 326 to obtain calibration measurements 328 of the optical calibration patterns 310. The calibration engine 316 may determine the calibration data 330 (e.g., color correction lookup tables) based on the calibration measurements 328. The calibration engine 316 may send the calibration data 330 to the TCON 304.

The TCON 304 stores 608 the calibration data 330 in memory 332 of the display 302. For example, the TCON 304 may save the calibration data 330 to memory 332 of the display 302. In some examples, the memory 332 may be included within the TCON 304. In other examples, the memory 332 may be located outside the TCON 304. In some examples, storing 608 the calibration data 330 may include applying the calibration data 330 to adjust the performance of the display 302.

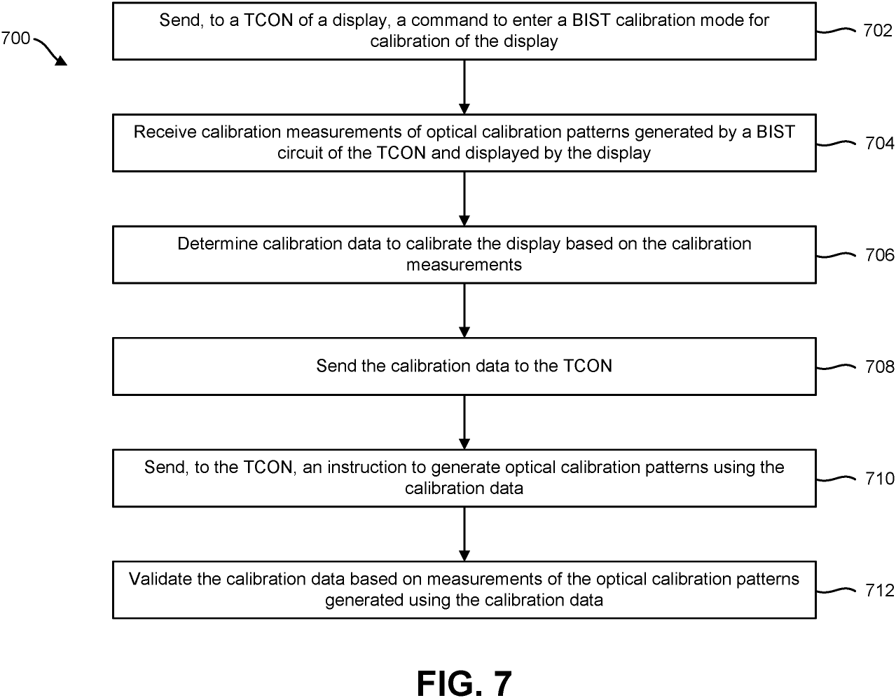

FIG. 7 is a flow diagram illustrating yet another example of a method 700 for display calibration. The method 700 may be performed by, for example, a calibration engine 316. In some examples, the calibration engine 316 may be implemented by a processor of a computing device 314.

The calibration engine 316 sends 702, to a TCON 304 of a display 302, a command 308 to enter BIST calibration mode 312 for calibration of the display 302. In some examples, the BIST calibration mode command 308 may be sent directly to the TCON 304. In other examples, the BIST calibration mode command 308 may be sent to a calibration fixture 546 that communicates the BIST calibration mode command 308 to the TCON 304. Upon receiving the BIST calibration mode command 308, a BIST circuit 306 of the TCON 304 may generate optical calibration patterns 310 that are displayed on a display screen 313 of the display 302.

The calibration engine 316 receives 704 calibration measurements 328 of the optical calibration patterns 310 generated by the BIST circuit 306 of the TCON 304 and displayed by the display 302. For example, the calibration engine 316 may receive 704 the calibration measurements 328 from an optical sensor 326 positioned to observe and measure the performance of the display screen 313 as the optical calibration patterns 310 are displayed.

The calibration engine 316 determines 706 calibration data 330 to calibrate the display 302 based on the calibration measurements 328. For example, the calibration engine 316 may compare expected light properties of the display screen 313 with the calibration measurements 328. Based on this comparison, the calibration engine 316 may determine correction values that the TCON 304 is to apply to adjust the performance (e.g., color performance) of the display 302.

The calibration engine 316 sends 708 the calibration data 330 to the TCON 304. For example, the calibration engine 316 may communicate the calibration data 330 directly to the TCON 304 over a communication interface. In another example, the calibration engine 316 may communicate the calibration data 330 to a calibration fixture 546 that then sends the calibration data 330 to the TCON 304. Upon receiving the calibration data 330, the TCON 304 may store the calibration data 330 in memory 332 of the display 302.

The calibration engine 316 may then validate the display calibration. For example, the calibration engine 316 may send 710, to the TCON 304, an instruction to generate optical calibration patterns 310 using the calibration data 330. Upon receiving this instruction, the BIST circuit 306 may generate the optical calibration patterns 310 while making adjustments to the emitted light according to the calibration data 330. For instance, the BIST circuit 306 may generate optical calibration patterns 310 while adjusting the color according to a color correction lookup table included in the calibration data 330.

The calibration engine 316 validates 712 the calibration data 330 based on measurements 328 of the optical calibration patterns 310 generated using the calibration data 330. For example, if the calibration measurements 328 match the expected properties of the optical calibration patterns 310, then the calibration data 330 is validated.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
receiving, at a timing controller (TCON) of a display, a command to enter a built-in self-test (BIST) calibration mode for calibration of the display; and
generating, by a BIST circuit of the TCON, optical calibration patterns to be displayed by the display.

2. The method of claim 1, further comprising:
receiving, at the TCON, calibration data to calibrate the display in
response to generating the optical calibration patterns; and storing the calibration data in memory of the display.

3. The method of claim 1, wherein the BIST circuit generates defined optical calibration patterns for color calibration of the display.

4. The method of claim 1, wherein the BIST circuit causes the optical calibration patterns to be displayed with a defined time-lapse for each optical calibration pattern.

5. The method of claim 1, wherein the optical calibration patterns comprise red-green-blue (RGB) triplets displayed by the display.

6. A timing controller (TCON) of a display, comprising:
a first interface to receive a command to enter a built-in self-test (BIST) calibration mode for calibration of the display; and
a BIST circuit to generate optical calibration patterns to be displayed by the display in response to receiving the command to enter the BIST calibration mode.

7. The TCON of claim 6, wherein the BIST circuit generates the optical calibration patterns in response to receiving, at the TCON, an instruction to generate the optical calibration patterns.

8. The TCON of claim 6, wherein the first interface comprises a general-purpose input/output (GPIO) line of the TCON to receive a pull-up signal or pull-down signal to enter the BIST calibration mode.

9. The TCON of claim 6, wherein the TCON disregards signals received at a display interface in response to entering the BIST calibration mode.

10. The TCON of claim 6, further comprising a second interface to receive a command to enter a manufacturing mode to allow the TCON the enter BIST calibration mode.

11. A non-volatile computer-readable medium for storing computer executable instructions for controlling a computing device to perform a method for calibrating a display, wherein execution of the executable instructions by a processor causes the computing device to:
send, to a timing controller (TCON) of the display, a command to enter a built-in self-test (BIST) calibration mode for calibration of the display;
receive calibration measurements of optical calibration patterns generated by a BIST circuit of the TCON and displayed by the display; and
determine calibration data to calibrate the display based on the calibration measurements.

12. The computer-readable medium of claim 11, wherein execution of the executable instructions by the processor further causes the computing device to send an instruction to generate the optical calibration patterns.

13. The computer-readable medium of claim 11, wherein execution of the executable instructions by the processor further causes the computing device to send the calibration data to the TCON.

14. The computer-readable medium of claim 11, wherein the calibration data comprises color correction lookup tables.

15. The computer-readable medium of claim 11, wherein execution of the executable instructions by the processor further causes the computing device to:
send, to the TCON, an instruction to generate optical calibration patterns using the calibration data; and
validate the calibration data based on measurements of the optical calibration patterns generated using the calibration data.
